(19) United States
(12) Patent Application Publication
(10) Pub. No.: US 2024/0257150 A1
(43) Pub. Date: Aug. 1, 2024

(54) Integrated Carbon Emissions Management Platform

(71) Applicants: Pallav Sarma, Danville, CA (US); Matt Elbert, Houston, TX (US); Fernando Gutierrez, Houston, TX (US); Ryan Hillard, League City, TX (US); Javad Rafiee, Houston, TX (US); Hillmert Solano, Medellin (CO)

(72) Inventors: Pallav Sarma, Danville, CA (US); Matt Elbert, Houston, TX (US); Fernando Gutierrez, Houston, TX (US); Ryan Hillard, League City, TX (US); Javad Rafiee, Houston, TX (US); Hillmert Solano, Medellin (CO)

(21) Appl. No.: 18/161,734

(22) Filed: Jan. 30, 2023

(51) Int. Cl. G06Q 30/018; G06Q 10/04

(52) U.S. Cl. CPC G06Q 30/018; G06Q 10/04

(57) ABSTRACT

The present invention provides an integrated carbon emissions management platform that may be configured to estimate, track, and benchmark carbon emissions and intensity of an organization. Specifically, the invention allows users to seamlessly integrate various sources of data for continuous estimation and monitoring of greenhouse gas emissions across the whole organization. It further integrates with production forecasts to provide an estimate of future carbon footprint and intensity to understand the GHG impact of different operational plans.

### FIELD OF THE INVENTION

Embodiments of the present invention are in the field of an integrated carbon emissions management platform which may be configured to estimate, track and benchmark carbon emissions and intensity of an organization.

### BACKGROUND OF THE INVENTION

Greenhouse gases (GHG) are considered to be a significant contributor to the global warming phenomenon. The GHG can trap heat in the atmosphere thus causing climatic change, depletion of the ozone layer, air pollution, acidification of water bodies, greenhouse effect, etc. The principal GHG responsible for the above-mentioned side effects are carbon dioxide, methane, nitrous oxide, and fluorinated gases such as hydrofluorocarbons, perfluorocarbons, and sulfur hexafluoride. A few types of chlorinated gases are also included in GHG. Out of these GHG, carbon dioxide occurs naturally and is also emitted into the atmosphere through other natural processes. Other ways of carbon dioxide emission are due to human activities such as industries, automobiles, etc.

It has become imperative for organizations to easily and accurately measure their carbon footprint, forecast the impact on emissions from operational decisions, monitor key sources of emissions, and ultimately minimize it via operational and other optimizations. Governments around the globe are taking steps to tackle the serious issue of carbon emissions through national policies. These national policies include the introduction of emissions trading programs, voluntary programs, carbon or energy taxes, and regulations and standards on energy efficiency and emissions. Such emissions monitoring and reporting require strenuous efforts as expertise and data from many domains are needed for accurate and detailed analysis of carbon footprint. Therefore, there is a need for a platform that can help users in continuous estimation, reporting, and forecasting of GHG emissions across the entire organization.

The present invention discloses a carbon emissions estimation and forecasting platform that allows users to seamlessly integrate various sources of data for continuous estimation and monitoring of GHG emissions across the whole organization. It further integrates with production forecasts to provide an estimate of future carbon footprint and intensity to understand the GHG impact of different operational plans.

### SUMMARY OF THE INVENTION

The present invention provides an integrated carbon emissions management platform. The platform includes a computing unit having a processor and memory configured to execute one or more programming instructions embodied thereon, a data acquisition module adapted to receive carbon emissions data pertaining to one or more assets of an organization from one or more data sources, a data processing module adapted to process the received carbon emission data from the one or more sources into a consistent single format organizational carbon emission data, a baseline calculation module adapted to estimate a baseline carbon emission estimates on the basis of obtained carbon emission data in combination with one or more predetermined baseline calculation parameters in accordance to the one or more programming instructions and a reporting module adapted to present one or more predetermined insights related to carbon emissions for the organization for internal or regulatory purposes, a forecasting module adapted to forecast future carbon emissions related to future operational activity, and a sensitivity module adapted to identify the importance of various equipment, sources and factors on carbon emissions.

In one embodiment, the data acquisition module comprises a central repository adapted to store data received from the one or more data sources.

In another embodiment the one or more data sources further comprise an in-facility data sources where in the in-facility data source includes data from one or more components present internally within the facility including but not limited to emission gathering equipment, assets, emission management ERP installed within the facility, and information feeds including manual entries.

In another embodiment, the one or more data sources further comprise an out-facility data source. The out-facility data source includes data from one or more components present externally to the facility such as news feeds, weather feed, social media feed, manual data import, or any other source of information available related to carbon emission data of assets within the facility.

In another embodiment, the one or more baseline calculation parameters include at least time periods, emissions sources to account for, models to use and other input variables of the baseline model.

In yet another exemplary embodiment, the predetermined insights comprise one or more baseline reporting, carbon emission forecasting, sensitivity analysis, continuous monitoring, collaboration analysis, traceability analysis and audit trails, aggregation analysis, benchmarking corporate reporting, and organization management.

In yet another embodiment, further comprising a data-sharing component adapted to enable sharing of data and/or insights to and/or from one or more external systems via an application programming interface (API).

In yet another embodiment, the reporting module comprises a customizable user interface graphically depicting the one or more predetermined insights onto an interactive dashboard.

In yet another exemplary embodiment, a method for managing carbon emissions data is provided. The method includes receiving data sets pertaining to carbon emission from one or more assets of an organization from one or more data sources, communicating the collected data sets to the processor of the computing unit; computing a baseline carbon emission estimate of the organization by processing programming instructions stored at the processor of the computing unit and reporting one or more predetermined insights related to carbon emissions for the organization.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of the invention.

FIG. 1 illustrates a block diagram of the integrated carbon emissions management platform, in accordance with an exemplary embodiment of the present invention.

FIG. 2 is a screenshot of an illustrative user interface of the baseline calculation module and the reporting module, in accordance with an exemplary embodiment of the present invention.

FIG. 3 is a screenshot of an illustrative user interface of a sensitivity analysis, in accordance with an exemplary embodiment of the present invention.

FIG. 4 is a screenshot of an illustrative user interface of carbon emission forecasting, in accordance with an exemplary embodiment of the present invention.

FIG. 5 is a screenshot of an illustrative user interface of a collaboration analysis, in accordance with an exemplary embodiment of the present invention.

FIG. 6 is a screenshot of an illustrative user interface of a traceability analysis, in accordance with an exemplary embodiment of the present invention.

FIG. 7 is a screenshot of an illustrative user interface of aggregation and benchmarking analysis, in accordance with an exemplary embodiment of the present invention.

FIG. 8 is a screenshot of an illustrative user interface of an ESG frameworks and standards module, in accordance with an exemplary embodiment of the present invention.

### DETAILED DESCRIPTION OF THE INVENTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical, chemical and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented.

Embodiments of the present invention provide an integrated carbon emissions management platform that may be configured to estimate, track, and benchmark the carbon emissions of an organization. In one embodiment, the integrated carbon emissions management platform may be configured to enable the organization to break down, analyze, track, and report its carbon emissions by a business unit, or a geographical region.

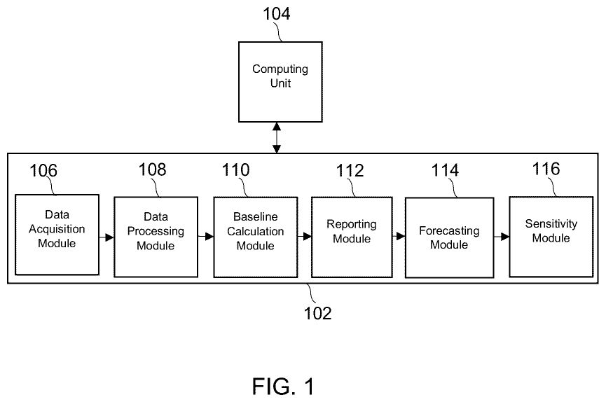

FIG. 1 illustrates a block diagram of the integrated carbon emissions management platform (102), in accordance with an exemplary embodiment of the present invention. The integrated carbon emissions management platform (102) includes a computing unit (104), a data acquisition module (106), a data processing module (108), a baseline calculation module (110), a reporting module (112), a forecasting module (114), and a sensitivity module (116). In one embodiment, the computing unit comprises a mobile or a touch-based computing hardware selected from but not limited to a smartphone, a tablet, and the like. The computing unit has a processor and memory configured to execute one or more programming instructions embodied thereon.

The data acquisition module (106) is adapted to receive carbon emissions data pertaining to one or more assets of an organization from one or more data sources. The one or more data sources include an in-facility data source or an out-facility data source. In one embodiment, the in-facility data source includes data from one or more components present internally within the facility including but not limited to emission-gathering equipment, assets, emission management ERP installed within the facility, information feeds including manual entries. In another embodiment, the out-facility data source includes data from one or more components present externally to the facility such as news feeds, weather feed, social media feed, manual data import, or any other source of information available related to carbon emission data of assets within the facility.

In one example, the organization may be oil and gas production. The plurality of assets can be a primary asset and a secondary asset. In one embodiment, the primary asset may be the oil and production field, production methods, production practices, processing practices, or land use impact. In another embodiment, the secondary asset may be exploration, drilling and development (DD), reservoir, well and downhole pump (WO), separation (SE), crude oil dewatering, crude oil storage, water injection, produced water treatment, makeup water treatment, glycol dehydrator, or any other asset related to oil and gas industry.

The data acquisition module (106) is adapted to perform one or more functions of extracting, loading, and transforming (ELT) the carbon emission data on a repetitive basis. The data processing module (108) is adapted to process the received carbon emission data from the one or more sources into a consistent single format organizational carbon emission data.

In one embodiment, the data acquisition module may securely obtain the carbon emissions data directly through a VPN/SSH tunnel or a secure file transfer protocol. The carbon emissions data is loaded or stored in a cloud-based storage. The carbon emissions data can be formatted into a JSON format. A JSON generator may be configured to generate JSON data from the obtained carbon emissions data. Further, the JSON data is stored in the cloud-based storage. The JSON data represent the consistent single format organizational carbon emission data.

Further, the baseline calculation module (110) is adapted to estimate baseline carbon emission estimates based on obtained carbon emission data in combination with one or more predetermined baseline calculation parameters in accordance to one or more programming instructions. The reporting module (112) is adapted to present one or more predetermined insights related to carbon emissions for the organization. The reporting module (112) comprises a user interface graphically depicting one or more predetermined insights onto an interactive dashboard.

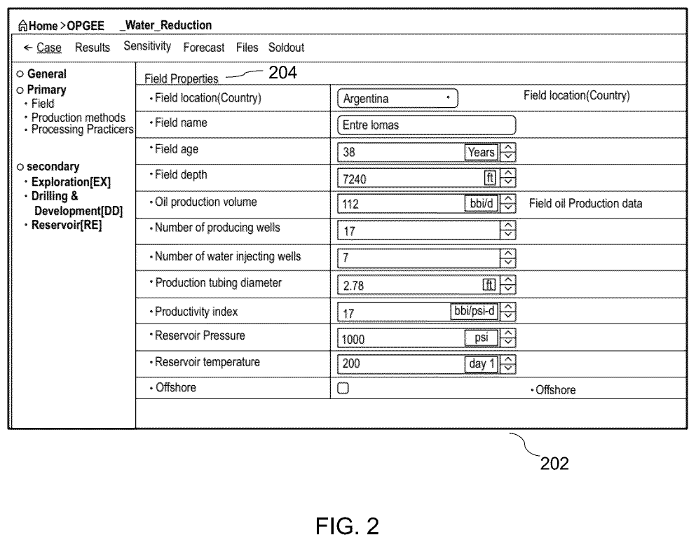

FIG. 2 is a screenshot of an illustrative user interface (202) of the baseline calculation module and the reporting module, in accordance with an exemplary embodiment of the present invention. The baseline estimation indicates the amount of carbon emission if no changes occur in the organization and provides a reference to compare the impact of any changes on the amount of carbon emission in a given period. The baseline calculation module is adapted to estimate a baseline carbon emission estimate based on obtained carbon emission data in combination with one or more predetermined baseline calculation parameters in accordance to the one or more programming instructions. In another exemplary embodiment, the one or more baseline calculation parameters include the oil and gas production field parameters (204) i.e., a field location, field age, field depth, oil production volume, number of producing wells, number of water injecting wells, production tubing diameter, productivity index, reservoir pressure, and reservoir temperature. The integrated carbon emissions management platform allows a user to input values of one or more parameters of the asset.

In another exemplary embodiment, the one or more programming instructions include OPGEE and subpart W models proposed by the Environmental Protection Agency (EPA). The OPGEE and subpart W models facilitate the estimation of the baseline for carbon intensity and footprint. The reporting module is adapted to present one or more predetermined insights related to carbon emissions for the organization. The predetermined insights include baseline reporting, carbon emission forecasting, sensitivity analysis, collaboration analysis, traceability analysis, aggregation analysis, benchmarking, corporate reporting, and organization management. Carbon emission forecasting is the predicted future carbon emissions of the organization. Further, the integrated carbon emissions management platform includes a data-sharing component adapted to enable sharing of data and/or insights to and/or from one or more external systems via an application programming interface (API). In one exemplary embodiment, the data-sharing component is to enable sharing of data and/or insights with the Environmental Protection Agency (EPA).

In another exemplary embodiment, the baseline calculation module may be configured to generate a carbon emission report of the organization using the obtained carbon emission data. The reporting module comprises a user interface graphically showing the carbon emission report for the organization onto an interactive dashboard. The carbon emissions report may include the total metric tons of carbon dioxide emitted by one or more assets of the organization. In one embodiment, the carbon emission report comprises one or more graphs representing the amount of carbon dioxide emitted by one or more assets of the organization. In one embodiment, the carbon emission report may include total metric tons of methane and nitrous oxide emitted by one or more assets of the organization. The carbon emission report comprises one or more graphs representing the amount of methane and nitrous oxide emitted by one or more assets of the organization.

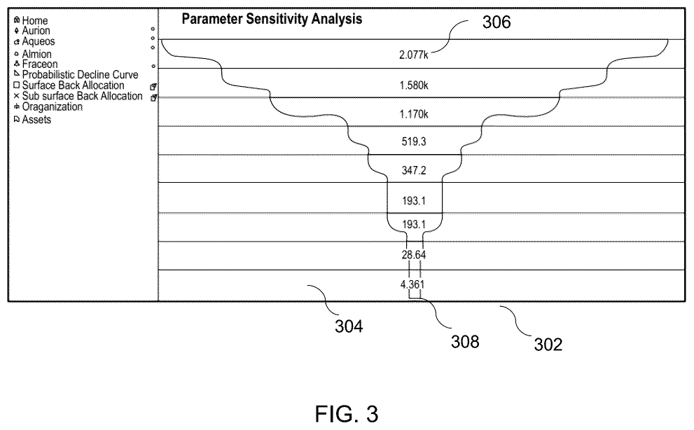

FIG. 3 is a screenshot of an illustrative user interface (302) of a sensitivity analysis, in accordance with an exemplary embodiment of the present invention. The computing unit enables the user to increase, decrease or change the values of one or more parameters of the asset to change the carbon emission of the organization. The sensitivity analysis is adapted to rank one or more parameters of the asset in one or more tornado charts (304). The highest-ranked parameter (306) is placed at the top and the lowest-ranked parameter (308) is placed at the bottom. The ranking of the parameters in one or more tornado charts (304) enables the user to identify the key parameters affecting the carbon emissions of the organization.

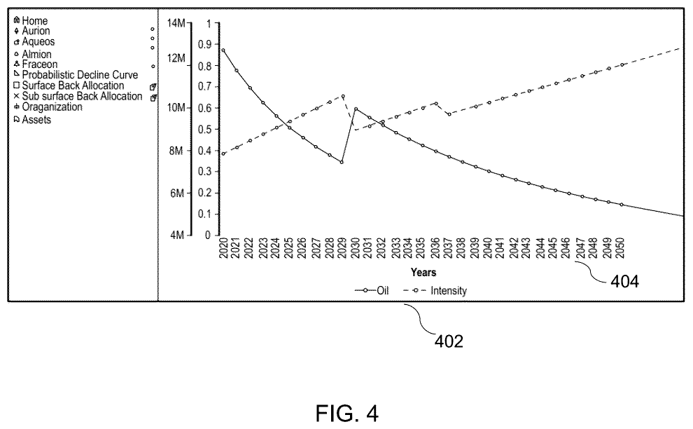

FIG. 4 is a screenshot of an illustrative user interface (402) of carbon emission forecasting, in accordance with an exemplary embodiment of the present invention. Carbon emission forecasting is the predicted future carbon emissions of the organization. The integrated carbon emissions management platform allows users to investigate the effect of future decisions on their carbon emissions. The integrated carbon emissions management platform allows for importing production and injection plans from the simulation and decline curve analysis. Further, any changes in the operations and emission sources can also be imported. The integrated carbon emissions management platform generates a time series (404) of the carbon emissions of the organization. The user interface of the reporting module graphically depicts the time series (404) of carbon emission emissions of the organization.

In one embodiment, carbon emission forecasting summarizes the forecast/prediction of carbon intensity and energy consumption of the organization. Carbon emission forecasting allows the user to identify the effect of changes on the carbon emissions where the changes may be made in the assets of the organization. The effect of changes may be the effect of adding, removing, or replacing the assets of the organization. In one example, one or more ESP pumps may be replaced by a gas lift or one or more high-bleeding pneumatic devices may be replaced with intermediate or low-bleed pneumatic devices to identify the effect of change in the assets.

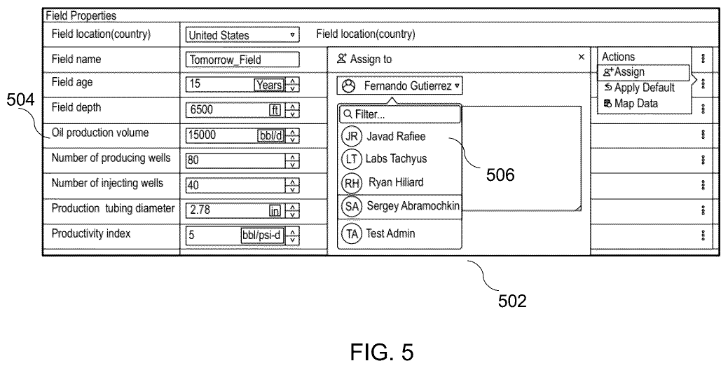

FIG. 5 is a screenshot of an illustrative user interface (502) of a collaboration analysis, in accordance with an exemplary embodiment of the present invention. The collaboration analysis allows a user to assign an activity (504) to one or more users (506) where the activity (504) may include reporting, tracking, and analyzing one or more assets of the organization. The integrated carbon emissions management platform enables the user to send a notification to one or more users (506) to assign the activity (504). The collaboration analysis enables one or more users (506) to respond, reject or even re-assign the activity (504) to another user in the organization. The collaboration analysis allows one or more users (506) to track and visualize the activity of one or more assets of the organization. Further, the collaboration analysis enables one or more users (506) to visualize updates made to the activity (504) of one or more assets of the organization. The collaboration analysis allows one or more users (506) to communicate and collaborate with other key subject matter experts in the organization.

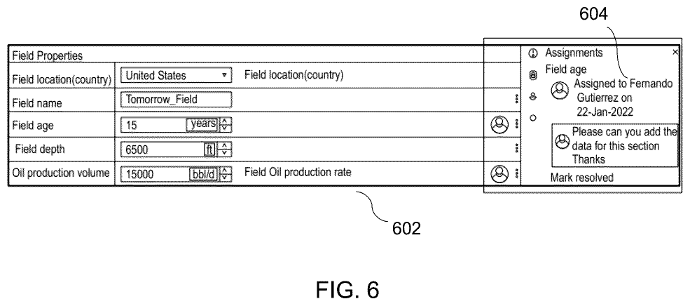

FIG. 6 is a screenshot of an illustrative user interface (602) of a traceability analysis, in accordance with an exemplary embodiment of the present invention. The integrated carbon emissions management platform provides audit logging across the organization. The audit logging may include a user name, activity information, activity assign date, parameters modified value, and activity close date. The traceability analysis allows the user to assign one or more parameters of the asset to one or more users (604). The integrated carbon emissions management platform is enabled to retain a snapshot of the state when it obtains the carbon emissions data. In one example, one or more users (604) may include a multidisciplinary team. The traceability analysis enables one or more users (604) to review, question, and verify the activity and updates made to the activity of one or more assets of the organization.

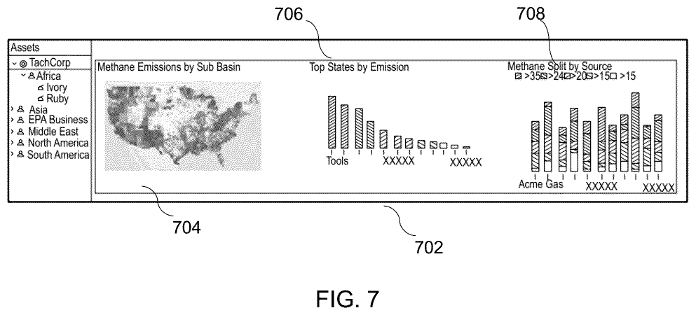

FIG. 7 is a screenshot of an illustrative user interface (702) of aggregation and benchmarking analysis, in accordance with an exemplary embodiment of the present invention. The integrated carbon emissions management platform comprises a data acquisition module adapted to receive carbon emissions data pertaining to one or more assets of the organization from one or more data sources. The carbon emissions data enables the organization to analyze, compare and benchmark its activities internally and externally. The aggregation and benchmarking analysis enable the user of the organization to make a decision based on their desired goals, industry segment, and geography. The benchmarking analysis enables the organization to set its desired goals, target industry, and desired aggregation layouts and visualizations. The aggregation and benchmarking analysis shows the methane emissions by sub-basin (704), top states by emission (706), methane split by source (708), methane intensity by sub-basin, top emissions sources by month, top partners vs actual, emission distribution by month, and venting and flaring by month.

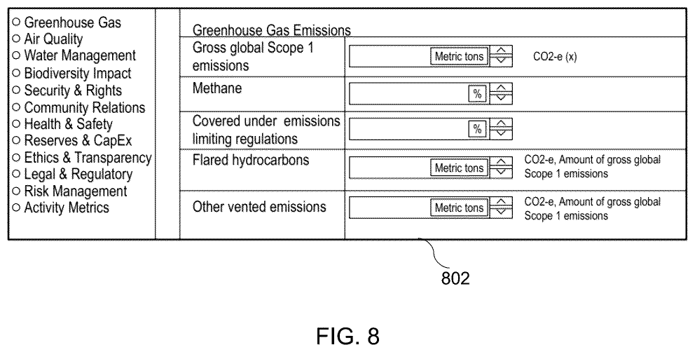

FIG. 8 is a screenshot of an illustrative user interface (802) of an ESG frameworks and standards module, in accordance with an exemplary embodiment of the present invention. The integrated carbon emissions management platform enables the organization to generate comparable, reliable, and steady ESG (Environmental, Social, and Governance) data from the organization. Further, the integrated carbon emissions management platform enables the organization to integrate with the ESG frameworks and standards (ESG F&S) for the organization to keep track of the ESG frameworks and standards concerns. The user interface of the ESG frameworks and standards shows the ESG frameworks and standards concerns such as greenhouse gas, air quality, water management, biodiversity impacts, community relations, risk management, or, any other ESG frameworks and standards concerns. The integrated carbon emissions management platform may include ESG frameworks and standards such as the Global Reporting Initiative (GRI), Dow Jones Sustainability indexes, the Climate Disclosure Standards Board (CDSB), the Sustainability Accounting Standards Board (SASB), and the Task force on Climate-related Financial Disclosures (TCFD).

In another exemplary embodiment, a method for managing carbon emissions data is provided. The method may be configured for receiving data sets pertaining to carbon emission from one or more assets of an organization from one or more data sources, communicating the collected data sets to the processor of the computing unit; computing a baseline carbon emission estimate of the organization by processing programming instructions stored at the processor of the computing unit and reporting one or more predetermined insights related to carbon emissions for the organization.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

1. An integrated carbon emissions management platform, comprising:
a computing unit having a processor and memory configured to execute one or more programming instructions embodied thereon;
a data acquisition module adapted to receive carbon emissions data pertaining to one or more assets of an organization from one or more data sources;
a data processing module adapted to process the received carbon emission data from the one or more sources into a consistent single format organizational carbon emission data;
a baseline calculation module adapted to estimate a baseline carbon emission estimate on the basis of obtained carbon emission data in combination with one or more predetermined baseline calculation parameters in accordance to the one or more programming instructions;
a reporting module adapted to present one or more predetermined insights related to carbon emissions for the organization for internal or regulatory purposes;
a forecasting module adapted to forecast future carbon emissions related to the future operational activity; and
a sensitivity module adapted to identify the importance of various equipment, sources, and factors on carbon emissions;

2. The integrated carbon emissions management platform of claim 1, wherein the one or more data sources further comprises an in-facility data source.

3. The integrated carbon emissions management platform of claim 2, wherein the in-facility data source includes data from one or more components present internally within the facility including but not limited to emission gathering equipment, assets, emission management ERP installed within the facility, and information feeds including manual entries.

4. The integrated carbon emissions management platform of claim 2, wherein the one or more data sources further comprises an out-facility data source.

5. The integrated carbon emissions management platform of claim 4, wherein the out-facility data source includes data from one or more components present externally to the facility such as news feeds, weather feed, social media feed, manual data import, or any other source of information available related to carbon emission data of assets within the facility.

6. The integrated carbon emissions management platform of claim 1, wherein the one or more baseline calculation parameters includes time periods, emissions sources to account for, models to use, and other input variables of the baseline model.

7. The integrated carbon emissions management platform of claim 1, wherein the predetermined insights comprise one or more of baseline reporting, carbon emission forecasting, sensitivity analysis, continuous monitoring, collaboration analysis, traceability analysis and audit trails, aggregation analysis, benchmarking, corporate reporting, and organization management.

8. The integrated carbon emissions management platform of claim 1, further comprising a data sharing component adapted to enable sharing of data and/or insights to and/or from one or more external systems via an application programming interface (API).

9. The integrated carbon emissions management platform of claim 1, wherein the computing unit comprises a mobile or a touch-based computing hardware.

10. The integrated carbon emissions management platform of claim 1, wherein the data acquisition module further comprises a central repository adapted to store data received from the one or more data sources.

11. The integrated carbon emissions management platform of claim 1, wherein the reporting module further comprises a customizable user interface graphically depicting the one or more predetermined insights onto an interactive dashboard.

12. A method for managing carbon emissions data, said method comprising:
receiving, data-sets pertaining to carbon emission from one or more assets of an organization from one or more data sources; communicating the collected data sets to the processor of the computing unit; computing a baseline carbon emission estimate of the organization by processing programming instructions stored at the processor of the computing unit; and
reporting one or more predetermined insights related to carbon emissions for the organization
